(19) United States
(12) Patent Application Publication
(10) Pub. No.: US 2018/0347844 A1
(43) Pub. Date: Dec. 6, 2018

(54) METHOD FOR SERVICING HEATING, VENTILATING OR AIR CONDITIONING SYSTEM

(71) Applicant: Zhongshan Broad-Ocean Motor Co., Ltd., Zhongshan (CN)

(72) Inventors: Yong ZHAO, Zhongshan (CN); Xiansheng ZHANG, Zhongshan (CN)

(21) Appl. No.: 15/870,889

(22) Filed: Jan. 13, 2018

(30) Foreign Application Priority Data
Jun. 2, 2017 (CN) 201710409205.9

(51) Int. Cl. F24F 11/63; F24F 11/49; H04L 29/08

(52) U.S. Cl. CPC F24F 11/63; F24F 11/49; F24F 2110/10; H04L 29/08; H04L 67/1097

(57) ABSTRACT

A method for servicing a heating, ventilating or air conditioning (HVAC) system. The method includes: 1) when the motor breaks down and requires replacing: providing a new motor to replace the broken motor; and acquiring, by the new motor, relevant data with regard to operating parameters of the new motor, from the data backup area of the memory of the control board; 2) when the control board breaks down: providing a new control board to replace the broken control board, the new control board including a programming unit; allowing the programming unit to communicate with a mobile phone which is connected to a cloud server; inputting and transmitting relevant information of the broken control board to the cloud server; searching, by the cloud server, operating parameters of the broken control board; rewriting the operating parameters of the broken control board into a memory of the new control board.

### CROSS-REFERENCE TO RELATED APPLICATIONS

Pursuant to 35 U.S.C. § 119 and the Paris Convention Treaty, this application claims the benefit of Chinese Patent Application No. 201710409205.9 filed Jun. 2, 2017, the contents of which are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

### Field of the Invention

The disclosure relates to a method for servicing a heating, ventilating or air conditioning (HVAC) system.

### Description of the Related Art

A typical HVAC system, as shown in FIG. 1, includes a control board, a compressor motor, a blower motor, and an axial fan motor. The control board includes a microprocessor, a memory and an interface unit. When one of the motors or the control board breaks down, a debugging process is required. Conventional debugging methods require updating the operating parameters of the motors, and then testing the operating parameters. However, the process is usually performed again and again, so it is inefficient, time-consuming, laborious, leading to high maintenance cost.

### SUMMARY OF THE INVENTION

In view of the above-described problems, it is one objective of the invention to provide a method for servicing a heating, ventilating or air conditioning (HVAC) system that is inexpensive and efficient.

To achieve the above objectives, in accordance with one embodiment of the invention, there is provided a method for servicing a heating, ventilating or air conditioning (HVAC) system, the HVAC comprising a control board and a motor adapted to process digital signals, the motor comprising a motor controller and a motor body, the motor controller comprising a power circuit, a microprocessor, an inverter circuit, and an I/O interface circuit; the motor body comprising a stator assembly, a rotor assembly, and a housing assembly; the control board being connected to and communicating with the motor controller; the control board comprising a memory having a data backup area for storing data with regard to the motor. The method comprises: when the motor breaks down and requires replacing, providing a new motor to replace the broken motor, and acquiring, by the new motor, relevant data with regard to operating parameters of the new motor, from the data backup area of the memory of the control board; when the control board breaks down, providing a new control board to replace the broken control board, the new control board comprising a programming unit equipped with a Bluetooth interface; allowing the programming unit to communicate with a mobile phone which is connected to a cloud server via a mobile communication network, the cloud server storing backups of operating parameters of a plurality of control boards; inputting and transmitting, by the mobile phone, relevant information of the broken control board to the cloud server; searching, by the cloud server, operating parameters of the broken control board; rewriting the operating parameters of the broken control board, by the mobile phone and the programming unit, into a memory of the new control board; and operating the HVAC system under the operating parameters of the new control board.

In a class of this embodiment, the mobile phone comprises an APP software operation module; the mobile phone is adapted to scan bar code information of the broken control board, the APP software operation module is adapted to acquire model data with regard to the broken control board based on the bar code information, and then acquire the operating parameters of the broken control board from the cloud server according to the model data of the broken control board.

Advantages of the method for servicing a heating, ventilating or air conditioning (HVAC) system of the disclosure are summarized as follows.

1. The control board comprises a memory having a data backup area for storing data with regard to the motor. When the motor breaks down and requires replacing, providing a new motor to replace the broken motor, and acquiring, by the new motor, relevant data with regard to operating parameters of the new motor, from the data backup area of the memory of the control board. When the control board breaks down, providing a new control board to replace the broken control board, the new control board comprising a programming unit equipped with a Bluetooth interface; allowing the programming unit to communicate with a mobile phone which is connected to a cloud server via a mobile communication network, the cloud server storing backups of operating parameters of a plurality of control boards; inputting and transmitting, by the mobile phone, relevant information of the broken control board to the cloud server; searching, by the cloud server, operating parameters of the broken control board; rewriting the operating parameters of the broken control board, by the mobile phone and the programming unit, into a memory of the new control board; and operating the HVAC system under the operating parameters of the new control board. The debugging process is rapid, convenient, shortens the testing time, and greatly reduces the maintenance cycle and saves the cost of maintenance.

2. The mobile phone comprises an APP software operation module; the mobile phone is adapted to scan bar code information of the broken control board, the APP software operation module is adapted to acquire model data with regard to the broken control board based on the bar code information, and then acquire the operating parameters of the broken control board from the cloud server according to the model data of the broken control board. The operation is easy and flexible, with high degree of intelligence, thus facilitating the maintenance.

### BRIEF DESCRIPTION OF THE DRAWINGS

The invention is described hereinbelow with reference to the accompanying drawings, in which:

FIG. 1 is a schematic diagram of a heating, ventilating or air conditioning (HVAC) system in the prior art;

FIG. 2 is a structural block diagram of a heating, ventilating or air conditioning (HVAC) system according to one embodiment of the disclosure;

FIG. 3 is a stereogram of a motor of a heating, ventilating or air conditioning (HVAC) system according to one embodiment of the disclosure;

FIG. 4 is a stereogram of a motor controller of a heating, ventilating or air conditioning (HVAC) system according to one embodiment of the disclosure;

FIG. 5 is a sectional view of a motor of a heating, ventilating or air conditioning (HVAC) system according to one embodiment of the disclosure; and

FIG. 6 is a circuit block diagram of a motor controller of a heating, ventilating or air conditioning (HVAC) system according to one embodiment of the disclosure.

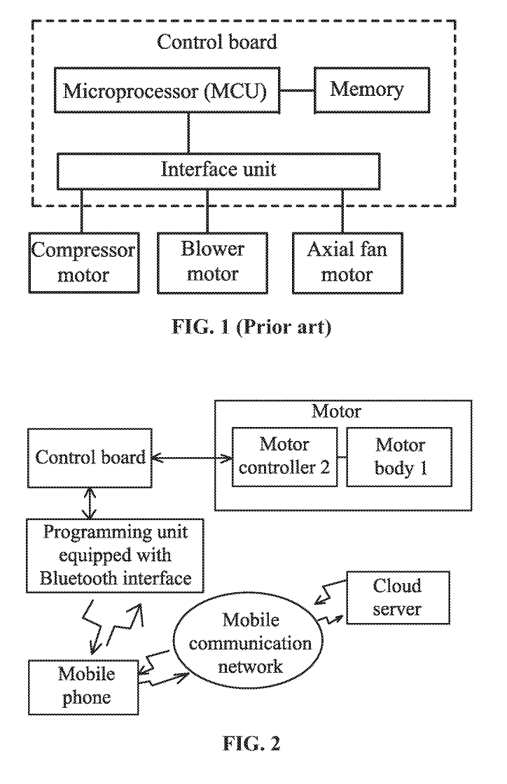

### DETAILED DESCRIPTION OF THE EMBODIMENTS

For further illustrating the invention, experiments detailing a method for servicing a heating, ventilating or air conditioning (HVAC) system are described below.

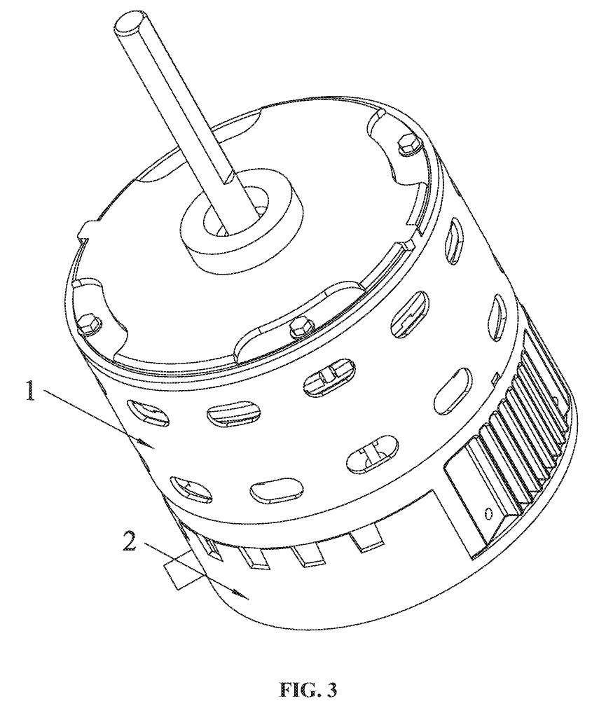

As shown in FIG. 2, a method for servicing a heating, ventilating or air conditioning (HVAC) system is provided. The HVAC comprises a control board and a motor adapted to process digital signals. The motor comprises a motor controller and a motor body. The motor controller comprises a power circuit, a microprocessor, an inverter circuit, and an I/O interface circuit. The motor body comprises a stator assembly, a rotor assembly, and a housing assembly. The control board is in communication connection with the motor controller. The control board comprises a memory having a data backup area for storing data with regard to the motor.

When the motor breaks down and requires replacing, providing a new motor to replace the broken motor, and acquiring, by the new motor, relevant data with regard to operating parameters of the new motor, from the data backup area of the memory of the control board.

When the control board breaks down, providing a new control board to replace the broken control board, the new control board comprising a programming unit equipped with a Bluetooth interface; allowing the programming unit to communicate with a mobile phone which is connected to a cloud server via a mobile communication network, the cloud server storing backups of operating parameters of a plurality of control boards; inputting and transmitting, by the mobile phone, relevant information of the broken control board to the cloud server; searching, by the cloud server, operating parameters of the broken control board; rewriting the operating parameters of the broken control board, by the mobile phone and the programming unit, into a memory of the new control board; and operating the HVAC system under the operating parameters of the new control board. The programming unit having the Bluetooth interface communicates with a mobile phone through Bluetooth communication protocol.

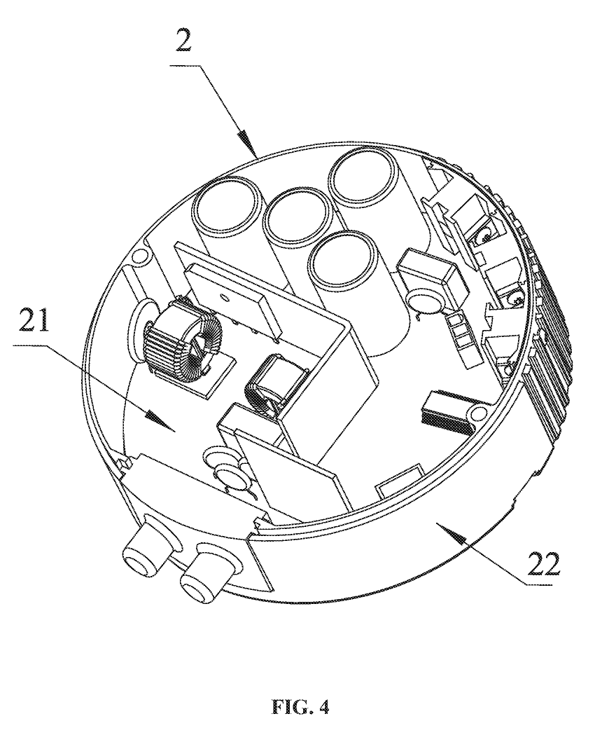

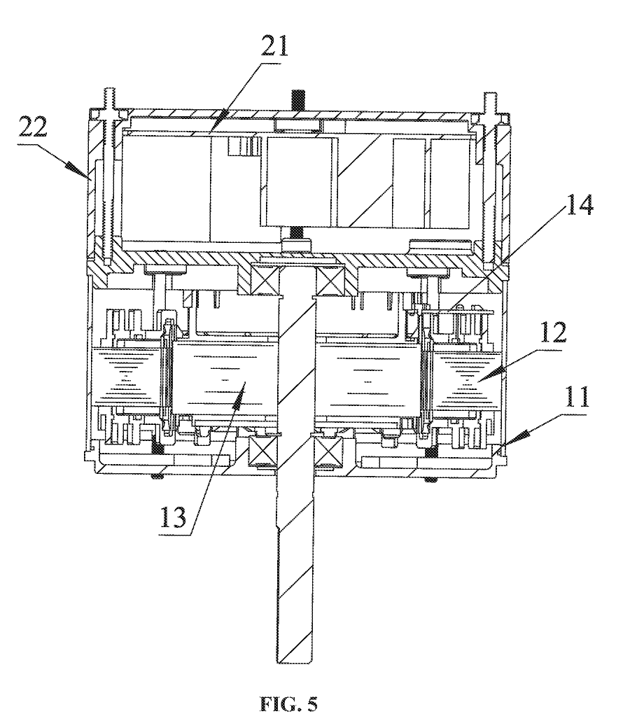

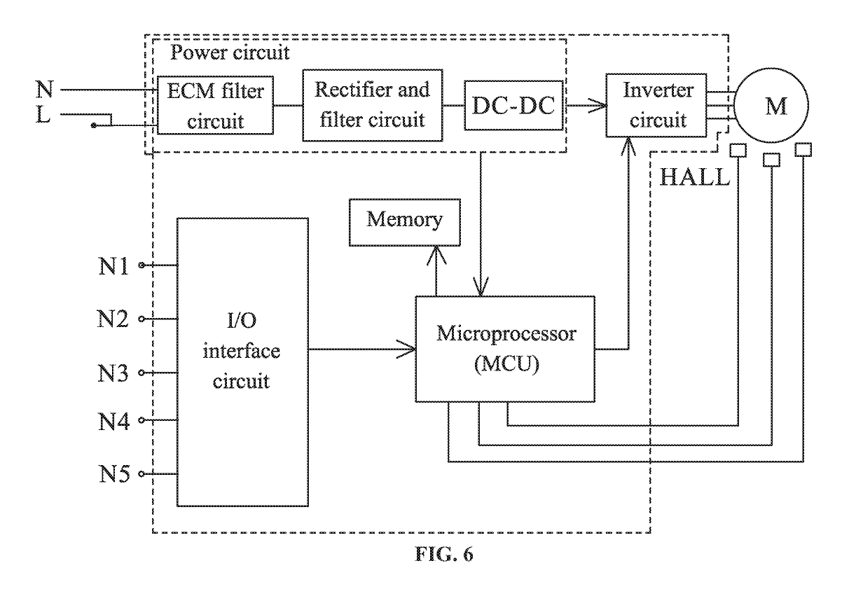

As shown in FIGS. 3-6, the motor comprises a motor controller 2 and a motor body 1, and the motor body 1 comprises a stator assembly 12, a rotor assembly 13, and a housing assembly 11. The rotor assembly 13 is disposed on the housing assembly 11. The motor body is equipped with a Hall element 14 to detect the rotor position. The rotor assembly 13 sleeves the inner side or the outer side of the stator assembly 12. The motor controller 2 comprises a control box 22 and a control circuit board 21 disposed in the control box 22. In general, the control box 22 comprises a power circuit, a microprocessor, a memory, an inverter circuit, and an I/O interface circuit. The power circuit supplies power for the other circuits. The Hall element 14 is adapted to detect the rotor position signal and transmits the signal to the microprocessor. The microprocessor controls the inverter circuit. The inverter circuit controls the on-off of the coil windings of each phase of the stator assembly 12, and the microprocessor is connected to and communicates with the control board via the I/O interface circuit. The control board and the motor controller can communicate with one another based on a communication protocol, for example, climate talk communication protocol.

The mobile phone comprises an APP software operation module; the mobile phone is adapted to scan bar code information of the broken control board, the APP software operation module is adapted to acquire model data with regard to the broken control board based on the bar code information, and then acquire the operating parameters of the broken control board from the cloud server according to the model data of the broken control board.

The memory connected to the microprocessor of the motor controller comprises ROM, RAM, and FLASH memory. The ROM memory is a volatile memory, and when the power is off, the data vanish completely. ROM and FLASH are non-volatile memory. ROM memory is adapted to store the drive program of a motor. FLASH memory is generally adapted to store the operating parameters of the motor, such as constant air volume coefficient, torque, rotation direction, rotation speed, air volume and rated power, and it is rewritable non-volatile memory.

The HVAC is easy to maintain when a breakdown happens. When a motor breaks down and requires replacing, the broken motor is directly replaced by a new motor. The control board of the system comprises a memory having a data backup area for storing the data with regard to the motor. When the motor breaks down and requires replacing, providing a new motor to replace the broken motor, and acquiring, by the new motor, relevant data with regard to operating parameters of the new motor, from the data backup area of the memory of the control board. When the control board breaks down, providing a new control board to replace the broken control board, the new control board comprising a programming unit equipped with a Bluetooth interface; allowing the programming unit to communicate with a mobile phone which is connected to a cloud server via a mobile communication network, the cloud server storing backups of operating parameters of a plurality of control boards; inputting and transmitting, by the mobile phone, relevant information of the broken control board to the cloud server; searching, by the cloud server, operating parameters of the broken control board; rewriting the operating parameters of the broken control board, by the mobile phone and the programming unit, into a memory of the new control board; and operating the HVAC system under the operating parameters of the new control board.

The operating parameters of the control board comprise: motor power, supplier code (ID number), operating modes (there are three modes, respectively, constant volume, constant torque, constant speed), air volume coefficient I, air volume coefficient II, air volume coefficient III, air volume coefficient IV, air volume coefficient V, rotation direction of the motor, set maximum air volume, rise speed of set target, motor speed, motor air flow, control state of the motor, and so on.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for servicing a heating, ventilating or air conditioning (HVAC) system, the HVAC system comprising a control board and a motor adapted to process digital signals; the motor comprising a motor controller and a motor body; the motor controller comprising a power circuit, a microprocessor, an inverter circuit, and an I/O interface circuit; the motor body comprising a stator assembly, a rotor assembly, and a housing assembly; the control board being connected to and communicating with the motor controller; the control board comprising a memory having a data backup area for storing data with regard to the motor; the method comprising:
1) when the motor breaks down and requires replacing:
providing a new motor to replace the broken motor; and
acquiring, by the new motor, relevant data with regard to operating parameters of the new motor, from the data backup area of the memory of the control board; or
2) when the control board breaks down:
providing a new control board to replace the broken control board, the new control board comprising a programming unit equipped with a Bluetooth interface;
allowing the programming unit to communicate with a mobile phone which is connected to a cloud server via a mobile communication network, the cloud server storing backups of operating parameters of a plurality of control boards;
inputting and transmitting, by the mobile phone, relevant information of the broken control board to the cloud server;
searching, by the cloud server, operating parameters of the broken control board;
rewriting the operating parameters of the broken control board, by the mobile phone and the programming unit, into a memory of the new control board; and
operating the HVAC system under the operating parameters of the new control board.

2. The method of claim 1, wherein the mobile phone comprises an APP software operation module; the mobile phone is adapted to scan bar code information of the broken control board, the APP software operation module is adapted to acquire model data with regard to the broken control board based on the bar code information, and then acquire the operating parameters of the broken control board from the cloud server according to the model data of the broken control board.
